(19) United States
(12) Patent Application Publication
(10) Pub. No.: US 2014/0244560 A1
(43) Pub. Date: Aug. 28, 2014

(54) Engagement and Experience Based Ranking

(71) Applicant: Google Inc., Mountain View, CA (US)

(72) Inventors: Natasha Mohanty, San Francisco, CA (US); Amogh Sanjay Asgekar, Mountain View, CA (US); Rudolf Michael Galfi, Mountain View, CA (US)

(73) Assignee: Google Inc., Mountain View, CA (US)

(21) Appl. No.: 13/774,084

(22) Filed: Feb. 22, 2013

(51) Int. Cl. G06N 5/02

(52) U.S. Cl. CPC G06N 5/02
USPC 706/46

(57) ABSTRACT

A method, computer program product, and computer system for identifying, by one or more computing devices, online posts authored by a user. The online posts are clustered according to one or more topics of the online posts authored by the user. Inputs associated with the online posts authored by the user are determined. A first score of the user is generated according to the one or more topics based upon a first portion of the inputs associated with the online posts authored by the user. A second score of the user is generated according to the one or more topics based upon a second portion of the inputs associated with the online posts authored by the user. A rank of the user according to the one or more topics is determined based upon the first and second score.

### BACKGROUND

The internet has provided a venue that makes it possible for almost anyone to share their ideas with the world. For example, people may use blogs and social networks to espouse their views on a particular topic by, e.g., “posting” on the respective blog and/or social network. These posts may, for example, attract comments from interested users that may agree, disagree, or simply ask a question. As a result, an online conversation may develop that may help to disseminate information. However, with so much information available to the world, it may be difficult for a user to determine, e.g., which conversations may be worth their time to follow and whose postings may be credible.

### SUMMARY OF DISCLOSURE

In one implementation, a method, performed by one or more computing devices, comprises identifying, by one or more computing devices, online posts authored by a user. The online posts are clustered according to one or more topics of the online posts authored by the user. Inputs associated with the online posts authored by the user are determined. A first score of the user is generated according to the one or more topics based upon a first portion of the inputs associated with the online posts authored by the user. A second score of the user is generated according to the one or more topics based upon a second portion of the inputs associated with the online posts authored by the user. A rank of the user according to the one or more topics is determined based upon the first and second score.

One or more of the following features may be included. The first score may include an engagement score based upon popularity. The first score may include an engagement score based upon interaction of the user with one or more other users. The second score may include an expertise score based upon an amount of content associated with the one or more topics published by the user in the online posts. The expertise score may be further based upon a length of time since at least a portion of the amount of content associated with the one or more topics was published by the user in the online posts. A suggestion of content may be provided to a second user based upon the rank of the user. The rank of the user may be rendered at one or more of the online posts.

In another implementation, a computing system includes a processor and a memory configured to perform operations comprising identifying, by one or more computing devices, online posts authored by a user. The online posts are clustered according to one or more topics of the online posts authored by the user. Inputs associated with the online posts authored by the user are determined. A first score of the user is generated according to the one or more topics based upon a first portion of the inputs associated with the online posts authored by the user. A second score of the user is generated according to the one or more topics based upon a second portion of the inputs associated with the online posts authored by the user. A rank of the user according to the one or more topics is determined based upon the first and second score.

One or more of the following features may be included. The first score may include an engagement score based upon popularity. The first score may include an engagement score based upon interaction of the user with one or more other users. The second score may include an expertise score based upon an amount of content associated with the one or more topics published by the user in the online posts. The expertise score may be further based upon a length of time since at least a portion of the amount of content associated with the one or more topics was published by the user in the online posts. A suggestion of content may be provided to a second user based upon the rank of the user. The rank of the user may be rendered at one or more of the online posts.

In another implementation, a computer program product resides on a computer readable storage medium that has a plurality of instructions stored on it. When executed by a processor, the instructions cause the processor to perform operations comprising identifying, by one or more computing devices, online posts authored by a user. The online posts are clustered according to one or more topics of the online posts authored by the user. Inputs associated with the online posts authored by the user are determined. A first score of the user is generated according to the one or more topics based upon a first portion of the inputs associated with the online posts authored by the user. A second score of the user is generated according to the one or more topics based upon a second portion of the inputs associated with the online posts authored by the user. A rank of the user according to the one or more topics is determined based upon the first and second score.

One or more of the following features may be included. The first score may include an engagement score based upon popularity. The first score may include an engagement score based upon interaction of the user with one or more other users. The second score may include an expertise score based upon an amount of content associated with the one or more topics published by the user in the online posts. The expertise score may be further based upon a length of time since at least a portion of the amount of content associated with the one or more topics was published by the user in the online posts. A suggestion of content may be provided to a second user based upon the rank of the user. The rank of the user may be rendered at one or more of the online posts.

Advantageously, by taking into account the above-noted scores of a user, it may be possible to recommend better users related to a topic it may be possible to recommend users who may provide greater longer-term value within the user's own social graph.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of a ranking process coupled to a distributed computing network according to one or more implementations of the present disclosure;

FIG. 2 is a diagrammatic view of a client electronic device of FIG. 1 according to one or more implementations of the present disclosure;

FIG. 3 is an illustrative flowchart of the ranking process of FIG. 1 according to one or more implementations of the present disclosure; and

FIG. 4 is an illustrative diagrammatic view of a screen image displayed by the ranking process of FIG. 1 according to one or more implementations of the present disclosure.

Like reference symbols in the various drawings indicate like elements.

### DETAILED DESCRIPTION

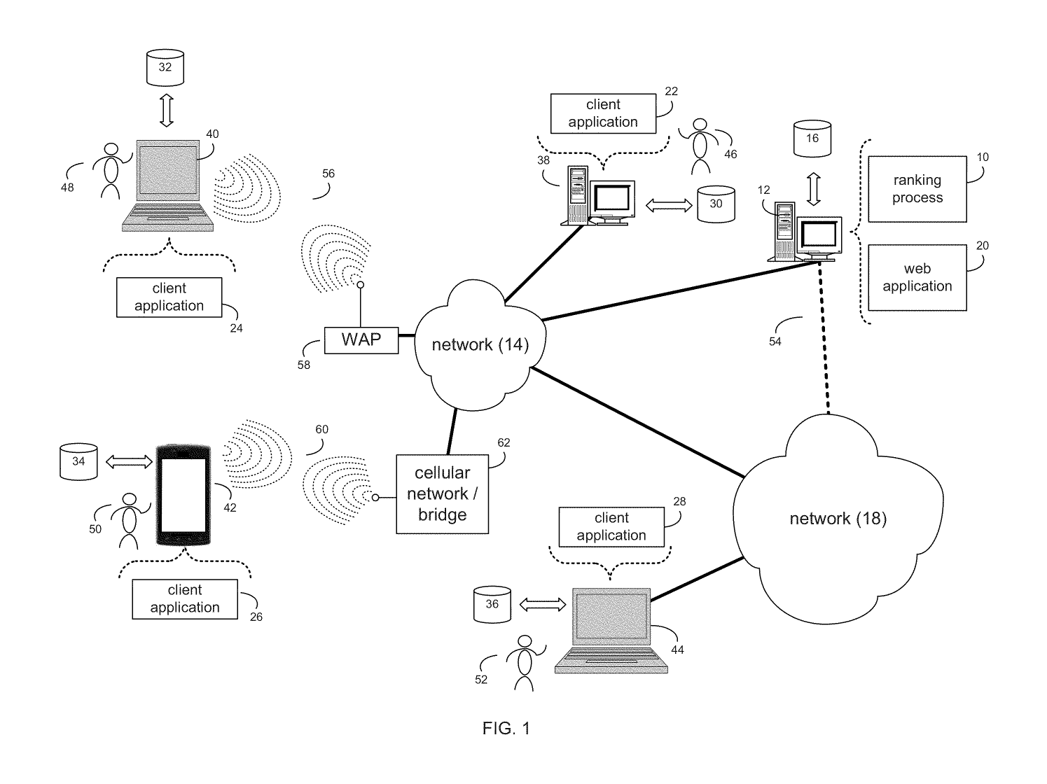

Referring to FIG. 1, there is shown ranking process 10 that may reside on and may be executed by a computer (e.g., computer 12), which may be connected to a network (e.g., network 14) (e.g., the internet or a local area network). Examples of computer 12 may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, a custom operating system.

As will be discussed below in greater detail, ranking process 10 may identify, by one or more computing devices, online posts authored by a user. The online posts may be clustered according to one or more topics of the online posts authored by the user. Inputs associated with the online posts authored by the user may be determined. A first score of the user may be generated according to the one or more topics based upon a first portion of the inputs associated with the online posts authored by the user. A second score of the user may be generated according to the one or more topics based upon a second portion of the inputs associated with the online posts authored by the user. A rank of the user may be determined according to the one or more topics based upon the first and second score.

The instruction sets and subroutines of ranking process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, etc.) and may be located within any suitable memory location, such as storage device 16 coupled to computer 12. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Ranking process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a web application (e.g., web application 20), examples of which may include, but are not limited to, e.g., a web server application, a social networking application, a blogging application, a web page hosting application, a web page management application, or other application that provides remote access to content via the internet. Ranking process 10 and/or web application 20 may be accessed via client applications 22, 24, 26, 28. Ranking process 10 may be a stand alone application, or may be an applet/application/script that may interact with and/or be executed within web application 20. Examples of client applications 22, 24, 26, 28 may include but are not limited to a social networking application, a blogging application, a web page hosting application, a web page management application, or other application that provides remote access to content via the internet, a standard and/or mobile web browser, an email client application, a textual and/or a graphical user interface, a customized web browser, a plugin, or a custom application. The instruction sets and subroutines of client applications 22, 24, 26, 28, which may be stored on storage devices 30, 32, 34, and 36 coupled to client electronic devices 38, 40, 42, 44, may be executed by one or more processors (not shown) and one or more memory architectures (not shown) incorporated into client electronic devices 38, 40, 42, 44.

Storage devices 30, 32, 34, and 36 may include but are not limited to: hard disk drives; flash drives, tape drives; optical drives; RAID arrays; random access memories (RAM); and read-only memories (ROM). Examples of client electronic devices 38, 40, 42, 44 may include, but are not limited to, a personal computer (e.g., client electronic device 38), a laptop computer (e.g., client electronic device 40), a smart phone (e.g., client electronic device 42), a notebook computer (e.g., client electronic device 44), a tablet (not shown), a server (not shown), a data-enabled, cellular telephone (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, a custom operating system.

One or more of client applications 22, 24, 26, 28 may be configured to effectuate some or all of the functionality of ranking process 10 (and vice versa). Accordingly, ranking process 10 may be a purely server-side application, a purely client-side application, or a hybrid server-side/client-side application that is cooperatively executed by one or more of client applications 22, 24, 26, 28 and ranking process 10.

One or more of client applications 22, 24, 26, 28 may be configured to effectuate some or all of the functionality of web application 20 (and vice versa). Accordingly, web application 20 may be a purely server-side application, a purely client-side application, or a hybrid server-side/client-side application that is cooperatively executed by one or more of client applications 22, 24, 26, 28 and web application 20.

Users 46, 48, 50, 52 may access computer 12 and ranking process 10 directly through network 14 or through secondary network 18. Further, computer 12 may be connected to network 14 through secondary network 18, as illustrated with phantom link line 54. Ranking process 10 may include one or more user interfaces, such as browsers and textual or graphical user interfaces, through which users 46, 48, 50, 52 may access ranking process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14. Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection.

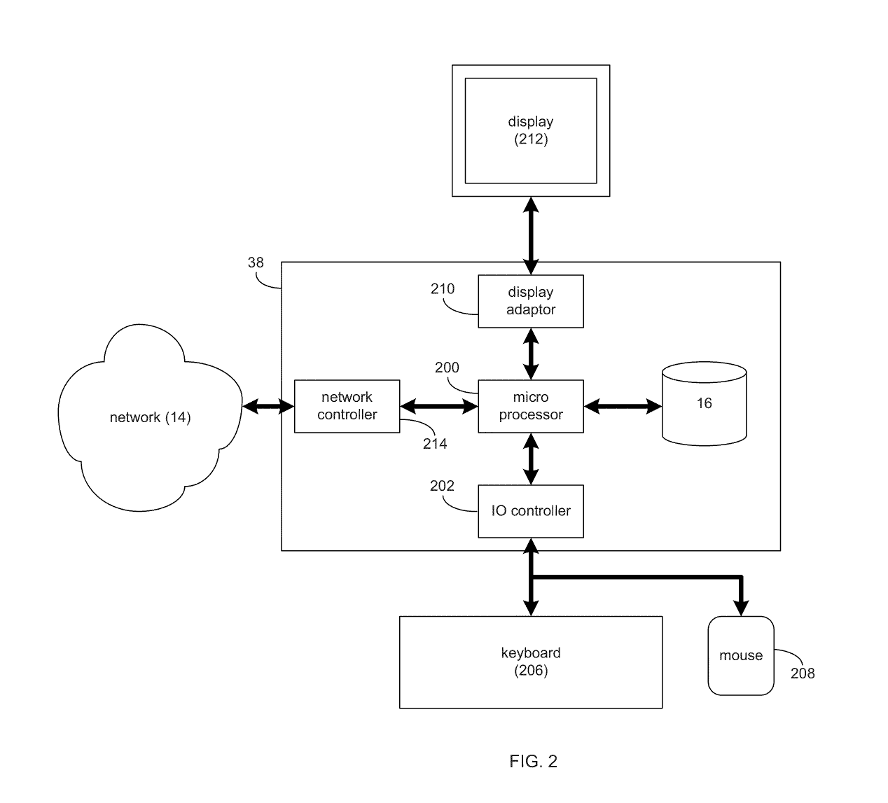

Referring also to FIG. 2, there is shown a diagrammatic view of client electronic device 38. While client electronic device 38 is shown in this figure, this is for illustrative purposes only and is not intended to be a limitation of this disclosure, as other configuration are possible. For example, any computing device capable of executing, in whole or in part, ranking process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device 16. An I/O controller (e.g., I/O controller 202) may be configured to couple microprocessor 200 with various devices, such as keyboard 206, pointing/selecting device (e.g., mouse 208), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

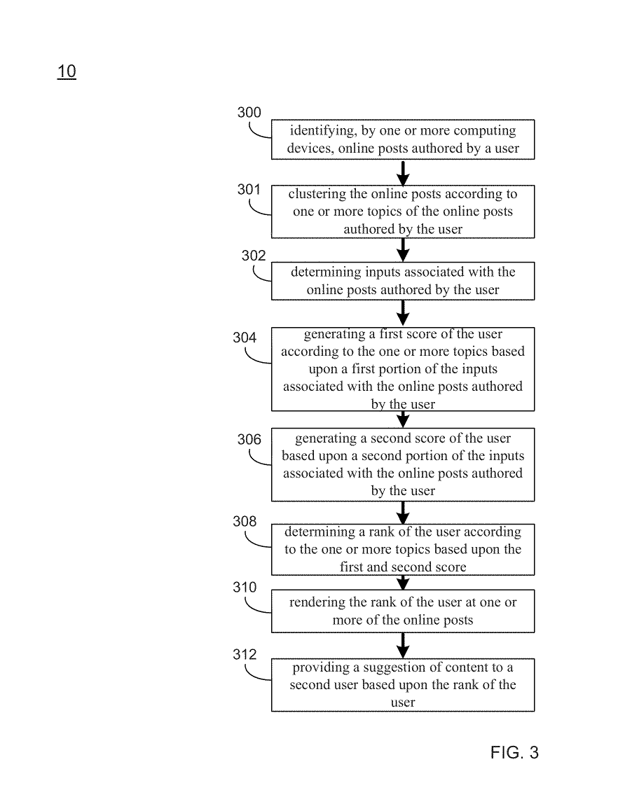

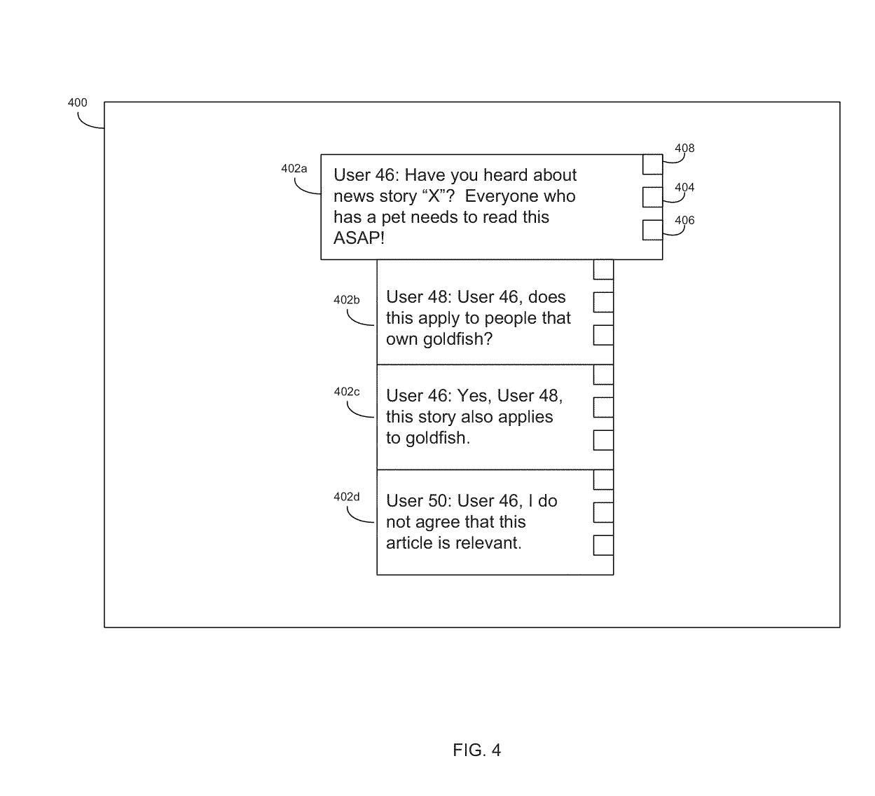

As discussed above and referring also to FIGS. 3-4, ranking process 10 may identify 300, by one or more computing devices, online posts authored by a user. The online posts may be clustered 301 by ranking process 10 according to one or more topics of the online posts authored by the user. Inputs associated with the online posts authored by the user may be determined 302 by ranking process 10. A first score of the user may be generated 304 by ranking process 10 according to the one or more topics based upon a first portion of the inputs associated with the online posts authored by the user. A second score of the user may be generated 306 by ranking process 10 according to the one or more topics based upon a second portion of the inputs associated with the online posts authored by the user. A rank of the user may be determined 308 by ranking process 10 according to the one or more topics based upon the first and second score.

In some implementations, ranking process 10 may identify 300, by one or more computing devices (e.g., computer 12), online posts authored by a user (e.g., user 46). For instance, assume for example purposes only that a user interface (e.g., UI 400) associated with, e.g., a social network, a blog, etc., includes one or more online posts (e.g., online posts 402a-d) authored by user 46. In the example, ranking process 10 (e.g., via computer 12) may identify 300 one or more of online posts 402a-d, which may be stored, e.g., in one or more data stores at, e.g., storage device 16. UI 400 need not be required for ranking process 10 to identify 300 one or more of online posts 402a-d.

In some implementations, as will be discussed in greater detail below, the online posts may be clustered 301 by ranking process 10 according to one or more topics of the online posts authored by the user. For example, the online posts may be clustered 301 by ranking process 10 according to one or more topics of the online posts (and similar topics authored by the user as will be discussed in greater detail below) in the above-noted online posts authored by the user. For instance, ranking process 10 may generate a cluster for a plurality of the above-noted online posts that are associated with the topic of, e.g., tennis. As another example, ranking process 10 may generate another cluster for a plurality of the above-noted online posts that are associated with the topic of, e.g., food.

In some implementations, inputs associated with the online posts authored by the user may be determined 302 by ranking process 10. Inputs associated with a portion of the online posts may include, for example, the content (e.g., text) of one or more online posts. For example, online post 402a may include, e.g., a comment regarding, e.g., tennis, food, and/or a recent news story “X”. The comment may have been posted by a user (e.g., user 46) via computer 38, client application 22, web application 20, ranking process 10, or combinations thereof.

As another example, online post 402b may include, e.g., a comment responding to online post 402a. For example, the comment may have been posted by a user (e.g., user 48) via computer 40, client application 24, web application 20, ranking process 10, or combinations thereof.

As another example, online post 402c may include, e.g., a comment from user 46 responding to the comment of user 48 in online post 402b. As another example, online post 402a may include, e.g., an ability for any user to share the content of, e.g., online post 402a, with other users. For instance, online post 402a may include a selectable portion (e.g., portion 404) that when selected by, e.g., user 48, may repost comment 402a (and/or each online post associate with online post 402a) to, e.g., a profile of user 48.

As another example, online post 402a may include, e.g., an ability for any user to recommend the content of online post 402a to themselves and/or other users. For instance, online post 402a may include a selectable portion (e.g., portion 406) that when selected by, e.g., user 48, may associate comment 402a (and/or each online post associated with online post 402a) with, e.g., a profile of user 48. The online posts may include other types of input (e.g., content and/or selectable portions) without departing from the scope of the disclosure. As such, the described inputs should be taken as an example only and not to otherwise limit the scope of the disclosure.

In some implementations, a first score of the user (e.g., user 46) may be generated 304 by ranking process 10 according to the one or more topics based upon (e.g., at least in part) a first portion of the inputs associated with the online posts authored by the user. In some implementations, the first score may include an engagement score based upon popularity. For instance, ranking process 10 may use any of the above-noted inputs of online posts 402a-d (e.g., the number of online posts shared/reshared, the number of comments, the number of recommendations, etc.) to generate 304 the first score (e.g., value). As an example, the engagement score for user 46 generated 304 by ranking process 10 may be modified (e.g., increased) as other users share/reshare, e.g., online post 402a and/or online posts 402b-d. As another example, the engagement score for user 46 generated 304 by ranking process 10 may be increased as the number of comments associated with, e.g., online post 402a and/or online posts 402b-d, by users (unique or otherwise) increases. As an example, the engagement score for user 46 generated 304 by ranking process 10 may increase as the number of recommendations associated with, e.g., online post 402a and/or online posts 402b-d, by users (unique or otherwise) increases.

In some implementations, any of the above-noted inputs may be weighted by ranking process 10 when generating 304 the first score. For example, the number of times an online post (e.g., online post 402a) is shared/reshared may not be weighted as high as the number of comments associated the online post (or vice versa).

In some implementations, the first score may include an engagement score based upon (e.g., at least in part) interaction of the user (e.g., user 46) with one or more other users. For example, assume for illustrative purposes only that user 48 has mentioned user 46 in online post 402b. Further assume that that user 50 has also mentioned user 46 in online post 402d. In the example, user 46 may have interacted with user 48 by, e.g., replying to online post 402b via online post 402c. This may modify, e.g., increase, the above-noted engagement score. Further in the example, user 46 may not have interacted with user 50 by, e.g., replying to online post 402d. This may modify, e.g., decrease, the above-noted engagement score.

In some implementations, the interaction of user 46 with one or more other users may include the number of online posts that mention (e.g., include in the text) one or more other users. For example, in online post 402c, user 46 has mentioned user 48. In the example, the mentioning of user 48 by user 46 in online post 402c may increase the first score of user 46.

As another example, the interaction of user 46 with one or more other users may include the number of online posts by user 46 that are commented on by user 46. For instance, in online post 402c, user 46 may be ostensibly commenting on the original online post of user 46 (e.g., online post 402a). In the example, the commenting by user 46 on his/her own online post may increase the first score of user 46.

As another example, the interaction of user 46 with one or more other users may include the number of online posts by user 46 that comment on online posts of others. For example, assume for illustrative purposes only that online post 402a may be considered a main online post as, e.g., it is the first online posting by user 46 in a string of online posts (e.g., online posts 402a-d). Further assume that online post 402b may be considered a sub-comment of online post 402a as it is not the first online posting by user 46 in the string of online posts. While online post 402b may be considered a sub-comment of online post 402a, online post 402b may still be considered an online post by user 48. As such, in the example, the commenting by user 46 on the online post of user 48 (e.g., via online post 402c) may increase the first score of user 46. In some implementations, sub-comments of online post 402a may be excluded from consideration as an online post by user 48 for purposes of generating 304 the first score based upon the number of online posts by user 46 that comment on online posts of others. As another example, the interaction of user 46 with one or more other users may include the number of online posts by user 46 that comment on online posts of others which also receive the above-described recommendations.

In some implementations, a second score of the user (e.g., user 46) may be generated 306 by ranking process 10 according to the one or more topics based upon (e.g., at least in part) a second portion of the inputs associated with the online posts authored by the user. In some implementations, the second score may include an expertise score based upon (e.g., at least in part) an amount of content associated with the one or more topics published by the user in the online posts. For example, each online post by user 46 associated with a particular topic (e.g., news story “X”) may modify, e.g., increase, the expertise score generated 306 by ranking process 10.

In some implementations, a combination of the expertise score with any combination of the above-noted engagement score may be used to generate 306 the second score. For example, an online post by user 46 associated with news story “X” that receive 2 comments from other users may be weighted less than an online post by user 46 associated with news story “X” that receive 5 comments from other users.

As another example, the number of online posts by user 46 associated with news story “X” compared to the number of online posts by user 46 not associated with news story “X” may modify the expertise score generated 306 by ranking process 10. For example, assume for illustrative purposes only that user 46 has numerous online posts associated with news story “X” and does not have any online posts that are not associated with news story “X”. For each online post by user 46 that is not associated with news story “X”, ranking process 10 may modify (e.g., decrease) the second score of user 46. Conversely, the more online posts by user 46 that are associated with news story “X” may modify (e.g., increase) the second score of user 46.

In some implementations, the expertise score may be further based upon (e.g., at least in part) a length of time since at least a portion of the amount of content associated with the one or more topics was published by the user (e.g., user 46) in the online posts. For instance, assume for example purposes only that ranking process 10 based upon online post 402a generates 306 the expertise score when online post 402a is posted. In the example, as online post 402a becomes “older”, ranking process 10 may generate 306 a new or updated expertise score for online post 402a (e.g., after each month). Additionally/alternatively, ranking process 10 may modify, e.g., decrease, the weight given to online post 402a after each month. Ranking process 10 may generate 306 an updated expertise score after other lengths of time (e.g., seconds, minutes, hours, days, weeks, months, years, etc). In some implementations, only the online posts less than, e.g., 60 days old, may be considered by ranking process 10.

In some implementations, a rank of the user (e.g., user 46) may be determined 308 by ranking process 10 according to the one or more topics based upon (e.g., at least in part) the first and second score. For example, based upon, e.g., the above-noted engagement score and/or the above-noted expertise score, ranking process 10 may determine 308 that user 46 has a rank of, e.g., 10. In some implementations, as discussed by example above, the rank of 10 for user 46 may be associated exclusively with the news story “X” topic and/or may be associated generally with user 46 for numerous topics. In some implementations, the rank of 10 may be determined 308 exclusively from online post 402a (and/or associated sub-posts), and/or may be determined 308 from other online posts authored by user 46.

As another example, referring at least to the above-noted discussion of ranking process 10 clustering 301 the online posts according to one or more topics of the online posts authored by the user, ranking process 10 may generate, e.g., a tennis topic cluster, that includes online posts about, e.g., famous tennis player X, Wimbledon, tennis, burgers, famous tennis player Y, tennis racquet, and baseball. In the example, assume for example purposes only that there are other topic clusters based upon other topics in the above-noted online posts. In the example:
1. Ranking process 10 may begin with the highest ranked topic, where i is the rank of a topic and where j is the rank of a user for the topic. Ranking process 10 may assign the rank i to a cluster.
2. Ranking process 10 may then move to next topic Tᵢ in a ranked list of the topic (clusters).
3. For each topic Tⱼ where j<i, ranking process 10 may lookup the similarity (Tᵢ, Tⱼ) in topic.
   a) If ranking process 10 determines that the similarity is greater than some predetermined confidence threshold, ranking process 10 may assign Tᵢ to the same cluster as Tⱼ, and break the loop, else
   b) Ranking process 10 may continue until j==i. If j==i, ranking process 10 may assign Tⱼ to a new cluster.
4. Ranking process 10 may multiply the above-noted rank of Tⱼ by a demotion factor computed as, e.g., (0.8 ̂ cluster_number), where the cluster_number is the number of clusters that exist when the cluster was created. Thus, the first cluster may have a cluster_number of 0, the second cluster may have a cluster_number of 1, etc.

In the above example, ranking process 10 may determine that a user is an expert in topics of famous tennis player X, Wimbledon, tennis, burgers, famous tennis player Y, tennis racquet, and baseball, where ranking process 10 may demote the rank of the user in the topics of burgers and baseball, while maintaining (and/or increasing) the rank of the user in the tennis related topics. In the example, each consecutively created cluster may have a higher and higher demotion.

In some implementations, ranking process 10 (e.g., via web application 20 and/or client application 22) may render 310 the rank at one or more of the online posts. For example, online post 402a may include a portion (e.g., portion 408) where the rank may be rendered 310. The rank may be rendered 310 in locations other than online post 402a. For example, the rank may be rendered 310 on a profile of user 46. In some implementations, the rank may be rendered as an ordered list of users (e.g., associated with a particular group of users, network of users, topic, etc.) according to the respective rank of others, e.g., by topic. In some implementations, the rank may be rendered 310 as, e.g., novice, average, expert, credible, not credible, etc., in place of or in addition to a numerical and/or variable rank.

In some implementations, ranking process 10 (e.g., via client application 22 and/or web application 20) fetch the engagement score from, e.g., one or more of the above-noted data stores, and/or via a remote procedure call (RPC) that uses an ID of user 46 as input. Optional parameters may also be used to determine, e.g., any preset twiddling on the engagement score, and/or return raw popularity and interactions numbers (if needed). Other techniques may be implemented by ranking process 10 to fetch the engagement score without departing from the scope of the disclosure.

In some implementations, ranking process 10 may, by exposing the appropriate Application Programming Interface (API), take in a topic ID (e.g., webref space) for news story “X” and a count for a number of experts on news story “X” to be returned. Optional parameters may return additional metadata such as base and relative expert scores, number of topical posts, or debug information, such as topic name. A relative expert score may include, for example, ranking process 10 not only considering those topics that exist in an online post for determining one or more of the above-noted scores, but also those topics similar to them. For example, ranking process 10 may identify 300 an online post about a famous tennis player, which may contribute towards a user's expertise score in the topic of tennis.

In some implementations, ranking process 10 (e.g., via web application 20 and/or client application 22) may provide 312 a suggestion of content to a second user (e.g., user 52 via client electronic device 44) based upon (e.g., at least in part) the rank of the user (e.g., user 46). For example, ranking process 10 may provide 312 user 52 with a suggestion to “follow” user 46 and/or add user 46 to a group associated with the topic of news story “X”. As another example, ranking process 10 may provide 312 user 52 with a notification that user 46 is a top contributor (e.g., to the topic of news story “X”) and/or may suggest that user 52 follow a conversation involving user 46. The suggestion may be provided 312 using multiple techniques, including, for example, email, text, and rendering the suggestion on a profile page of user 52 (e.g., as a feed). Ranking process 10 may provide 312 user 52 with other suggestions without departing from the scope of the disclosure. In some implementations, the suggestion of content may be provided 312 to user 52 with or without consideration of any current (or previously held) social connection between user 46 and user 52. For example, whether or not user 46 and user 52 are friends may be need not be relevant when providing 312 the above-noted suggestion of user content.

In some implementations, user 46 may “opt out” from having his/her online posts considered by ranking process 10. Opting out may include, for example, having ranking process 10 ignore some or all posts authored by user 46 and/or preventing any rankings from being rendered 310 to other users.

The present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be written in an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript or PERL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider).

The flowchart and block diagrams in the figures illustrate the architecture, functionality, and operation of possible implementations of apparatus (systems), methods and computer program products according to various implementations of the present disclosure. It will be understood that each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A computer-implemented method comprising:
identifying, by one or more computing devices, online posts authored by a user;
clustering the online posts according to one or more topics of the online posts authored by the user;
determining inputs associated with the online posts authored by the user;
generating a first score of the user according to the one or more topics based upon a first portion of the inputs associated with the online posts authored by the user;
generating a second score of the user according to the one or more topics based upon a second portion of the inputs associated the online posts authored by the user; and
determining a rank of the user according to the one or more topics based upon the first and second score.

2. The computer-implemented method of claim 1 further comprising providing a suggestion of content to a second user based upon the rank of the user.

3. The computer-implemented method of claim 1 further comprising rendering the rank of the user at one or more of the online posts.

4. The computer-implemented method of claim 1 wherein the first score includes an engagement score based upon popularity.

5. The computer-implemented method of claim 1 wherein the first score includes an engagement score based upon interaction of the user with one or more other users.

6. The computer-implemented method of claim 1 wherein the second score includes an expertise score based upon an amount of content associated with the one or more topics published by the user in the online posts.

7. The computer-implemented method of claim 6 wherein the expertise score is further based upon a length of time since at least a portion of the amount of content associated with the one or more topics was published by the user in the online posts.

8. A computing system including a processor and a memory configured to perform operations comprising:
identifying, by one or more computing devices, online posts authored by a user;
clustering the online posts according to one or more topics of the online posts authored by the user;
determining inputs associated with the online posts authored by the user;
generating a first score of the user according to the one or more topics based upon a first portion of the inputs associated with the online posts authored by the user;
generating a second score of the user according to the one or more topics based upon a second portion of the inputs associated the online posts authored by the user; and
determining a rank of the user according to the one or more topics based upon the first and second score.

9. The computing system of claim 8 further comprising providing a suggestion of content to a second user based upon the rank of the user.

10. The computing system of claim 8 further comprising rendering the rank of the user at one or more of the online posts.

11. The computing system of claim 8 wherein the first score includes an engagement score based upon popularity.

12. The computing system of claim 8 wherein the first score includes an engagement score based upon interaction of the user with one or more other users.

13. The computing system of claim 8 wherein the second score includes an expertise score based upon an amount of content associated with the one or more topics published by the user in the online posts.

14. The computing system of claim 13 wherein the expertise score is further based upon a length of time since at least a portion of the amount of content associated with the one or more topics was published by the user in the online posts.

15. A computer program product residing on a computer readable storage medium having a plurality of instructions stored thereon which, when executed by a processor, cause the processor to perform operations comprising:
identifying, by one or more computing devices, online posts authored by a user;
clustering the online posts according to one or more topics of the online posts authored by the user;
determining inputs associated with the online posts authored by the user;
generating a first score of the user according to the one or more topics based upon a first portion of the inputs associated with the online posts authored by the user;
generating a second score of the user according to the one or more topics based upon a second portion of the inputs associated the online posts authored by the user; and
determining a rank of the user according to the one or more topics based upon the first and second score.

16. The computer program product of claim 15 further comprising providing a suggestion of content to a second user based upon the rank of the user.

17. The computer program product of claim 15 further comprising rendering the rank of the user at one or more of the online posts.

18. The computer program product of claim 15 wherein the first score includes an engagement score based upon popularity.

19. The computer program product of claim 15 wherein the first score includes an engagement score based upon interaction of the user with one or more other users.

20. The computer program product of claim 15 wherein the second score includes an expertise score based upon an amount of content associated with the one or more topics published by the user in the online posts.
